(19) United States
(12) Patent Application Publication
(10) Pub. No.: US 2014/0168088 A1
(43) Pub. Date: Jun. 19, 2014

(54) KEYBOARD WITH LIGHTING APPARATUS AND LIGHTING METHOD THEREOF

(71) Applicant: HON HAI PRECISION INDUSTRY CO., LTD., New Taipei (TW)

(72) Inventors: HSIANG-PIN TSENG, New Taipei (TW); MIN-WEI LEE, New Taipei (TW)

(73) Assignee: HON HAI PRECISION INDUSTRY CO., LTD., New Taipei (TW)

(21) Appl. No.: 13/972,235

(22) Filed: Aug. 21, 2013

(30) Foreign Application Priority Data
Dec. 14, 2012 (TW) 101147688

(51) Int. Cl. G06F 3/02

(52) U.S. Cl. CPC G06F 3/0219
USPC 345/170

(57) ABSTRACT

A keyboard includes a key portion, an inputting detecting module, and a lighting controlling module. The key portion includes a plurality of key caps aligned in a regular fashion. Each of the plurality of key caps includes a letter identifier and a first assistant identifier and a second assistant identifier printed thereon. The inputting detecting module detects a current input of a letter of the alphabet, a first assistant identifier, or a second assistant identifier, of the keyboard. The lighting controlling module is connected to the inputting detecting module. The lighting controlling module lights the particular identifier, either letter, or first assistant identifier, or second assistant identifier, on the key cap when the inputting detecting module detects such an input by the keyboard.

### BACKGROUND

1. Technical Field

The present disclosure generally relates to a keyboard, and particularly to a keyboard having a lighting apparatus and lighting method thereof.

2. Description of Related Art

With the popularity of computers, consumers not only require computers with efficiency but are also paying more attention to the functions and designs of computer accessories such as keyboards. Some keyboards are equipped with backlit keys so that a user can perform input tasks under inadequate lighting. However, because there are a plurality of backlit keys on the keyboard, light emitted from the plurality of backlit keys are too desultory to affect the users.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a view of a keyboard according to one embodiment.

FIG. 2 is a block view of the keyboard of FIG. 1.

FIGS. 3 and 4 are a flowchart of a lighting method of the keyboard of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

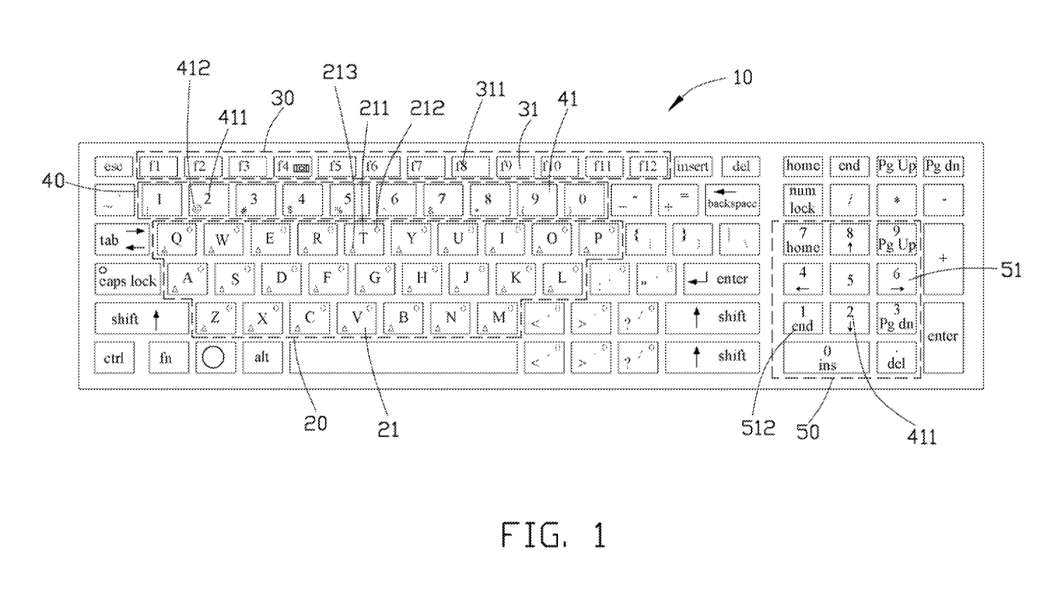

FIG. 1 shows that an embodiment of a keyboard 10 includes an alphabet key portion 20, a first function key portion 30, a first number key portion 40, and a second number key portion 50.

The alphabet key portion 20 includes a plurality of alphabet key caps 21 aligned therein. Each alphabet key cap 21 has three kinds of identifier printed thereon. The three kinds of identifier are an alphabet identifier 211, a first assistant identifier 212, and a second assistant identifier 213. The alphabet identifier 211 (such as “A”, “B”, and “C”) is printed on a center portion of the alphabet key cap 21. The first assistant identifier 212 is printed on an upper right corner of the alphabet key cap 21. In the embodiment, a circle “o” indicates the first assistant identifier 212. The second assistant identifier 213 is printed on an lower left corner of the alphabet key cap 21. In the embodiment, a triangle “Δ” indicates the second assistant identifier 212.

The first number key portion 40 is located above the alphabet key portion 20. The first number key portion 40 includes a plurality of first number key caps 41 aligned therein. Each first number cap 41 has two kinds of identifier printed thereon. The two kinds of identifier are firstly a number identifier 411 (such as “1”, “2”, and “3”) and a first aid identifier 412 (such as “!”, “@”, and “#”). The number identifier 411 is printed in a center portion of the first number key cap 41. The first aid identifier 412 is printed in a lower left corner of the first number key cap 41.

The first function key portion 30 is located above the first number key portion 40. The first function key portion 30 includes a plurality of first function key caps 31 aligned therein. Each first function key caps 31 has a function identifier 311 (such as “f1”, “f2”, and “f3”) printed thereon.

The second number key portion 50 is located on a right hand side of the alphabet key portion 20. The second number key portion 50 includes a plurality of second number key caps 51 aligned therein. Each second number cap 51 has a number identifier 411 at a center portion thereof and a second aid identifier 512 at a lower portion thereof.

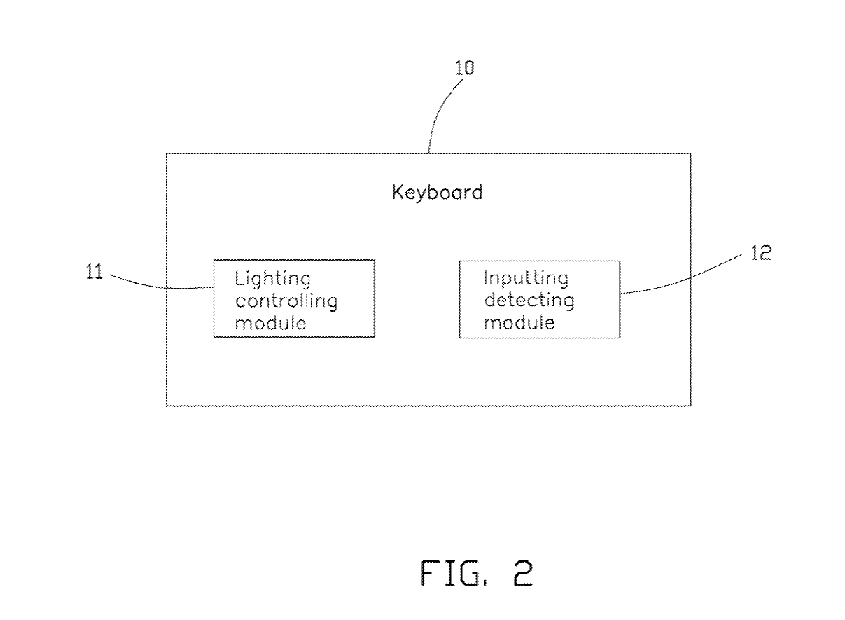

FIG. 2 shows a block view of the keyboard 10. The keyboard 10 includes a lighting controlling module 11 and an inputting detecting module 12. The lighting controlling module 11 is connected to the inputting detecting module 12. The inputting detecting module 12 detects an inputting status of the keyboard 10. For example, the inputting detecting module 12 detects a key which is pressed and the location in which the pressed key is located. The lighting controlling module 11 controls the outlines of the identifiers on the key caps 21, 31, 41, 51, or the identifiers themselves, to light.

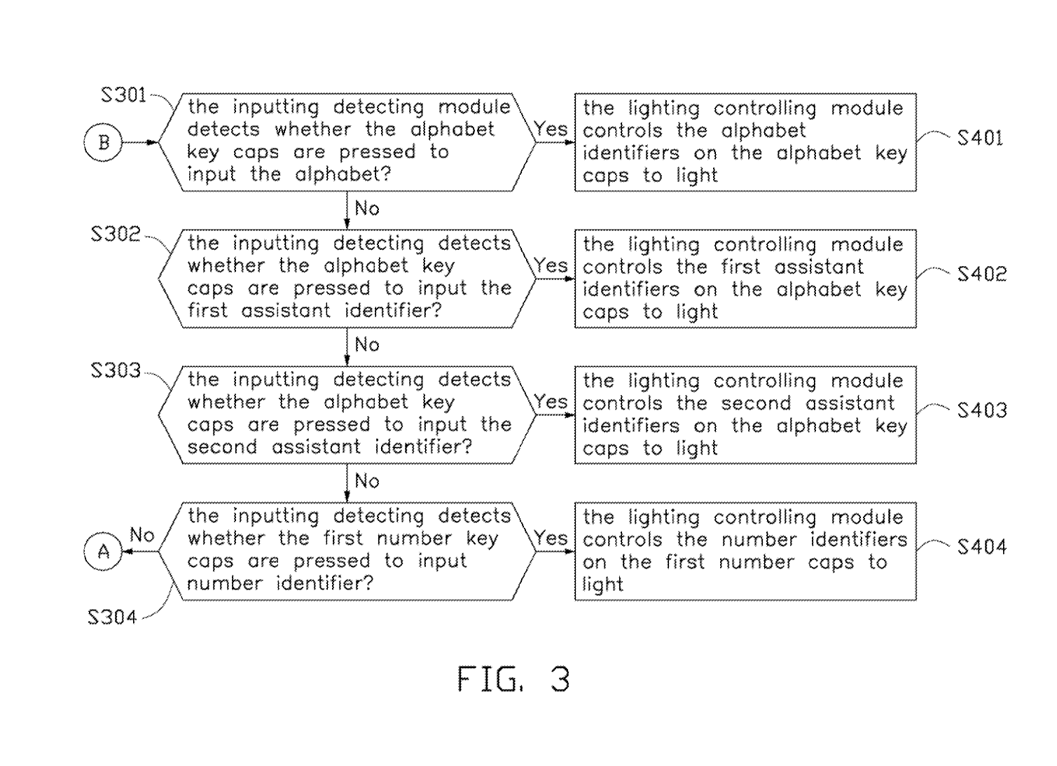

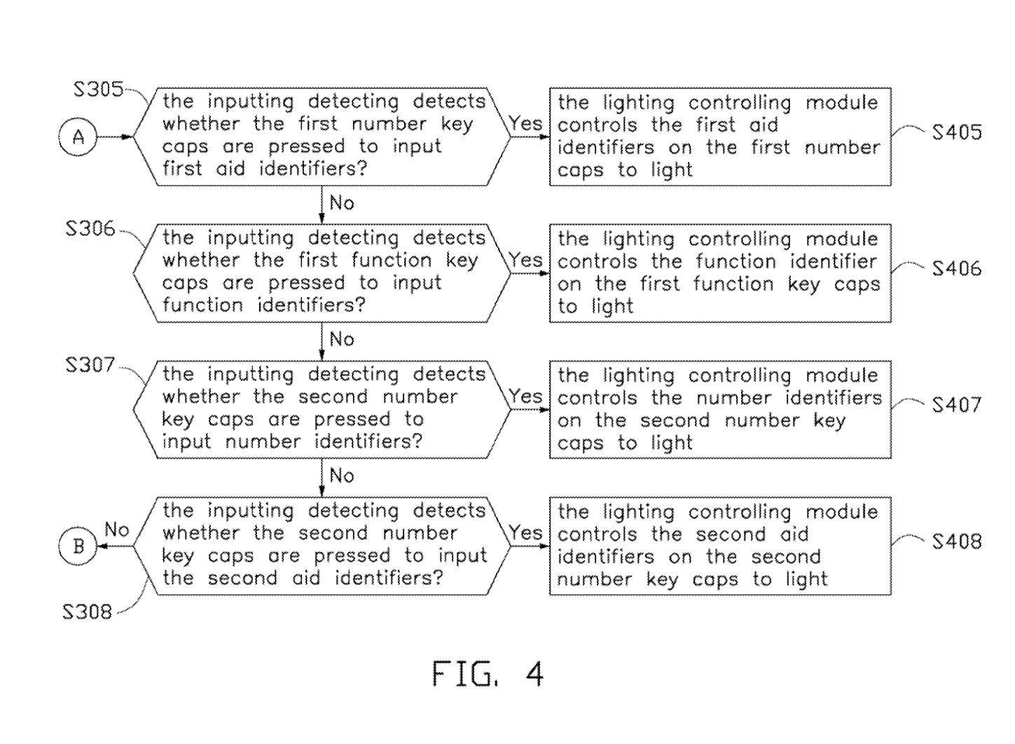

FIGS. 3 and 4 show a flowchart of a method of the keyboard 10 lighting. The method includes following steps:

In step 301, the inputting detecting module 12 detects whether the alphabet key caps 21 are pressed to input the alphabet identifier? If it is, step 401 is invoked. If it is not, step 302 is taken.

In step 302, the inputting detecting module 12 detects whether the alphabet key caps 21 are pressed to input the first assistant identifier? If it is, step 402 is taken. If it is not, step 303 is taken.

In step 303, the inputting detecting module 12 detects whether the alphabet key caps 21 are pressed to input the second assistant identifier? If it is, step 403 is taken. If it is not, step 304 is taken.

In step 304, the inputting detecting module 12 detects whether the first number key caps 41 are pressed to input number identifier? If it is, step 404 is taken. If it is not, step 305 is taken.

In step 305, the inputting detecting module 12 detects whether the first number key caps 41 are pressed to input first aid identifiers? If it is, step 405 is taken.

If it is not, step 306 is taken.

In step 306, the inputting detecting module 12 detects whether the first function key caps 31 are pressed to input function identifiers? If it is, step 406 is taken. If it is not, step 307 is taken.

In step 307, the inputting detecting module 12 detects whether the second number key caps 51 are pressed to input number identifiers? If it is, step 407 is taken. If it is not, step 308 is taken.

In step 308, the inputting detecting module 12 detects whether the second number key caps 51 are pressed to input the second aid identifiers? If it is, go to step 408. If it is not, go to step 301.

In step 401, the lighting controlling module 11 controls the alphabet identifiers 211 on the alphabet key caps 21 to light.

In step 402, the lighting controlling module 11 controls the first assistant identifiers 212 on the alphabet key caps 21 to light.

In step 403, the lighting controlling module 11 controls the second assistant identifiers 213 on the alphabet key caps 21 to light.

In step 404, the lighting controlling module 11 controls the number identifiers 411 on the first number caps 41 to light.

In step 405, the lighting controlling module 11 controls the first aid identifiers 412 on the first number caps 41 to light.

In step 406, the lighting controlling module 11 controls the function identifier 311 on the first function key caps 31 to light.

In step 407, the lighting controlling module 11 controls the number identifiers 411 on the second number key caps 51 to light.

In step 408, the lighting controlling module 11 controls the second aid identifiers 512 on the second number key caps 51 to light.

In the above keyboard 10, only the current inputting identifier is lighted. Therefore, it is easy for user to press the corresponding key cap.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A keyboard, comprising:
an alphabet key portion comprising a plurality of alphabet key caps aligned therein, each of the plurality of alphabet key caps comprising an alphabet identifier and a first assistant identifier printed thereon;
an inputting detecting module configured to detect a current inputting identifier of the keyboard; and
a lighting controlling module connected to the inputting detecting module, wherein the lighting controlling module is configured to light the alphabet identifiers on the plurality of alphabet key caps when the inputting detecting module detects the alphabet identifier is inputted by the keyboard, and the lighting controlling module is configured to light the first assistant identifiers on the plurality of alphabet key caps when the inputting detecting module detects the first assistant identifier is inputted by the keyboard.

2. The keyboard of claim 1, wherein the alphabet identifier is located on a center portion of each of the plurality of alphabet key caps, and the first assistant identifier is printed on an upper right corner of each of the plurality of the alphabet key caps.

3. The keyboard of claim 2, further comprises a second assistant identifier printed on an lower left corner of each of the plurality of alphabet key caps, wherein the lighting controlling module is configured to light the second assistant identifiers on the plurality of alphabet key caps when the inputting detecting module detects the second assistant identifier is inputted by the keyboard.

4. The keyboard of claim 1, further comprising a first number key portion, wherein a plurality of first number key caps is located in the first number key portion, each of the plurality of first number key caps comprises a number identifier and a first aid identifier printed thereon, the lighting controlling module is configured to light the number identifiers on the plurality of first number key caps when the inputting detecting module detects the number identifier is inputted by the keyboard, and the lighting controlling module is configured to light the first aid identifiers on the plurality of first number key caps when the inputting detecting module detects the first aid identifier is inputted by the keyboard.

5. The keyboard of claim 4, wherein the first number key portion is located above the alphabet key portion.

6. The keyboard of claim 5, further comprising a first function key portion located above the first number key portion, wherein the first function key portion comprises a plurality of first function key caps aligned therein, each of the plurality of first function key caps comprises a first function identifier printed thereon, and the lighting controlling module is configured to light the first function identifiers on the plurality of first function key caps when the inputting detecting module detects the first function identifier is inputted by the keyboard.

7. The keyboard of claim 1, further comprising a second number key portion located on a right portion of the alphabet key portion, wherein a plurality of second number key caps is located in the second number key portion, each of the plurality of first number key caps comprises a number identifier and a second aid identifier printed thereon, the lighting controlling module is configured to light the number identifiers on the plurality of second number key caps when the inputting detecting module detects the number identifier is inputted by the keyboard, and the lighting controlling module is configured to light the second aid identifiers on the second number key caps when the inputting detecting module detects the second aid identifier is inputted by the keyboard.

8. A keyboard, comprising:
a first key portion comprising a plurality of first key caps aligned therein, each of the plurality of first key caps comprising a first identifier attached thereon;
a second key portion comprising a plurality of second key caps aligned therein, each of the plurality of second key caps comprising a second identifier attached thereon;
an inputting detecting module configured to detect a current inputting identifier of the keyboard; and
a lighting controlling module connected to the inputting detecting module, wherein the lighting controlling module is configured to light the first identifiers on the plurality of first key caps when the inputting detecting module detects the first identifier is inputted by the keyboard, and the lighting controlling module is configured to light the first identifiers on the plurality of second key caps when the inputting detecting module detects the second assistant identifier is inputted by the keyboard.

9. A lighting method of a keyboard, the keyboard comprising an alphabet key portion which comprises a plurality of alphabet key caps aligned therein, each of the plurality of alphabet key caps comprising an alphabet identifier and a first assistant identifier printed thereon, the lighting method comprising:
detecting a current inputting identifiers of the keyboard by an inputting detecting module;
lighting the alphabet identifiers on the plurality of alphabet key caps when the inputting detecting module detects the alphabet identifier is inputted by the keyboard; and
lighting the first assistant identifiers on the alphabet key caps when the inputting detecting module detects the first assistant identifier is inputted by the keyboard.
